(19) United States
(12) Patent Application Publication
(10) Pub. No.: US 2006/0163853 A1
(43) Pub. Date: Jul. 27, 2006

(54) Air bag with gas blocking sealant at sewn seams

(76) Inventor: Ramesh Keshavaraj, Peachtree City, GA (US)

Correspondence Address: Sara M. Current;Legal Department, M-495, 920 Milliken Road, PO Box 1926, Spartanburg, SC, 29304, US

(21) Appl. No.: 11/040,383

(22) Filed: Jan. 21, 2005

(51) Int. Cl. B60R 21/233

(52) U.S. Cl. 280/743.1; 280/730.2

(57) ABSTRACT

An inflatable air bag structure formed from panels joined together along one or more sewn seams. The sewn seams are sealed at the interior between the adjoined layers by a low modulus, high elongation sealant surrounding at least a portion of the sewing threads. The sealant fails under tension in a cohesive manner by tearing through the interior of the sealant layer while remaining adhered to the fabric thereby maintaining gas blockage when the seam is placed in tension.

### TECHNICAL FIELD

This invention relates generally to vehicle air bags and more particularly to air bag cushions formed from panels of material joined together by sewn seams. A sealant of defined character is disposed at the interior of the sewn seams to block gas leakage for an extended period of time upon inflation of the air bag when the seams are placed in tension.

### BACKGROUND OF THE INVENTION

An air bag safety restraint in the form of an impact absorbing inflatable cushion in opposing relation to a vehicle occupant and/or an inflatable restraining curtain disposed along the side of a vehicle between an occupant and window or door openings plays a well recognized role in preventing injury to the occupant during a collision event. Typically, such air bags are inflated rapidly by the pressure of a reaction gas released from an inflator at the outset of the collision event. This gas generation typically takes place when a gas-generating agent in the inflator induces a chemical reaction activated by a collision signal from a collision detecting sensor when deceleration of the vehicle exceeds a certain level. The gas which is generated by the inflator is then conveyed to the air bag. Impact absorbing cushions are deployed outwardly from storage positions such as a dash panel, steering column or the like. Inflatable restraint curtains are typically deployed downwardly from a storage position along the roof rail so as to at least partially cover window and/or door openings across the side of the vehicle. The deployed curtain thus provides both a degree of cushioning restraint as well as a barrier preventing the occupant from being ejected from the vehicle. Due to the extended duration of a roll-over collision event where the vehicle may turn over several times, it is desirable for the curtain-type air bags to remain inflated for an extended period of time so as to maintain a degree of head protection and barrier restraint until the entire event is concluded. Preferably, such curtain-type restraint cushions remain inflated for about 6 seconds or more.

Air bag cushions formed by sewing together panels of fabric typically cannot maintain inflation for extended periods of time. Performance can be improved by applying substantial quantities of permeability blocking coating materials. However, applying sufficient coating weights to the fabric layers gives rise to substantial weight increase and bulk thereby increasing cost and making storage more difficult. Since the gas release in a sewn air bag is predominately at the seams, one solution that has been utilized is to weave the air bag as a one piece structure on a Jacquard loom and to then apply a relatively heavy layer of permeability blocking coating to cover the entire structure including the woven in seams. While Jacquard weaving has provided bag structures meeting desired performance requirements, the practice is nonetheless relatively expensive and inefficient to carry out. Moreover, even with woven in seams, air bags such as curtain type bags that are required to maintain inflation for extended periods may still require relatively high coating weights.

### SUMMARY OF THE INVENTION

The present invention provides advantages and alternatives over the prior art by providing air bag structures formed by joining together panels of textile fabrics using sewn seams that nonetheless resists gas leakage over an extended period of time upon inflation.

According to one aspect of the invention an inflatable air bag structure is provided formed from panels of textile fabric or the like joined together along one or more sewn seams. The sewn seams are sealed at the interior between the adjoined layers by a low modulus, high elongation polymeric sealant surrounding at least a portion of the sewing threads. Due to the low modulus and high elongation characteristics of the sealant it fails under tension in a cohesive manner by tearing through the interior of the sealant layer while remaining adhered to the fabric thereby maintaining gas blockage even when the seam is placed in tension.

### BRIEF DESCRIPTION OF THE DRAWINGS

The accompanying drawings which are incorporated in and which constitute a portion of this specification illustrate an exemplary embodiment of the invention which, together with the detailed description set forth below will serve to explain the principles of the invention wherein;

FIG. 1 illustrates a cut-away view of a transportation vehicle illustrating an inflatable air bag cushion in deployment to the side of the occupant;

FIG. 2 is a cut-through view of a generic seam construction securing together two panels of material with an interior sealant layer;

FIG. 2A is a view similar to FIG. 2 with the seam under tension; and

FIG. 3 is a graph showing pressure degradation versus time for a sewn air bag curtain in accordance with the present invention and prior art side-curtain constructions.

### DESCRIPTION OF PREFERRED EMBODIMENTS

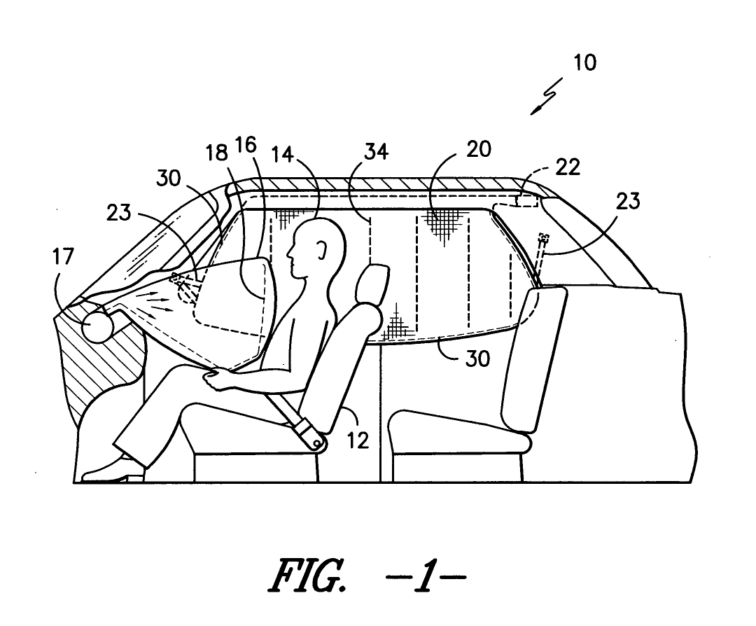

Reference will now be made to the drawings wherein, to the extent practical like elements are denoted by like reference numerals in the various views. Turning to FIG. 1 the interior of a transportation vehicle 10 is shown. As will be appreciated, the transportation vehicle may have any number of configurations such as a car, truck, van, sport utility vehicle or the like. Regardless of the actual vehicle configuration, it will include one or more rows of seats 12 for supporting an occupant 14.

As illustrated, the vehicle 10 includes an impact absorbing air bag 16 for use with an inflator 17 for rapid deployment in opposing relation to the occupant. The impact absorbing air bag 16 may be formed from one or more blanks of material such as woven fabric or the like joined along seams 18. In accordance with the present invention at least a portion of the seams 18 may be sewn seams formed by passing sewing thread in a stitching arrangement between opposing panels. Of course, it is to be understood that the illustrated impact absorbing air bag 16 is exemplary only and that any number of other geometries as may be known to those of skill in the art are likewise applicable to the present invention so long as they incorporate some percentage of sewn seams. Of course, additional impact absorbing air bags may likewise be deployed from the steering column and other locations within the vehicle 10 in a manner as will be well known to those of skill in the art.

As shown the vehicle 10 also includes an air bag in the form of an inflatable curtain 20 for use with an inflator 22 to protect the occupant 14 during a prolonged roll-over collision event. In operation, upon inflation the inflatable curtain 20 deploys downwardly from a storage position along the roof rail of the vehicle 10 into the illustrated position to the side of the occupant 14. As the curtain 20 is inflated it undergoes a natural shortening in its length dimension thereby causing it to be held in tension by tethering elements 23 at either end. By maintaining this tension, the curtain 20 forms an effective resilient barrier preventing ejection of the occupant 14. Thus, in order to maintain the desired end-to-end tension in the curtain 20, it is desirable to maintain inflation for the entire duration of the roll-over event.

In practice, the curtain 20 may be formed from two opposing mirror image panels of material such as a woven textile fabric joined along a perimeter seam 30. Of course, any number of other construction practices may likewise be utilized. By way of example only, the panels may be portions of a single fabric blank that is folded over upon itself and seamed around open edges. As illustrated, additional adjoining seams may be applied at the interior of the curtain 20 so as to define an arrangement of so called zero length tethers 34 to control gas flow and deployment characteristics within the inflatable curtain 20. In accordance with the present invention at least a portion of the perimeter and/or interior seams may be sewn seams formed by passing sewing thread in a stitching arrangement between opposing panels. Of course, it is to be understood that the illustrated curtain 20 is exemplary only and that any number of other curtain geometries as may be known to those of skill in the art are likewise applicable to the present invention so long as they incorporate some percentage of sewn seams.

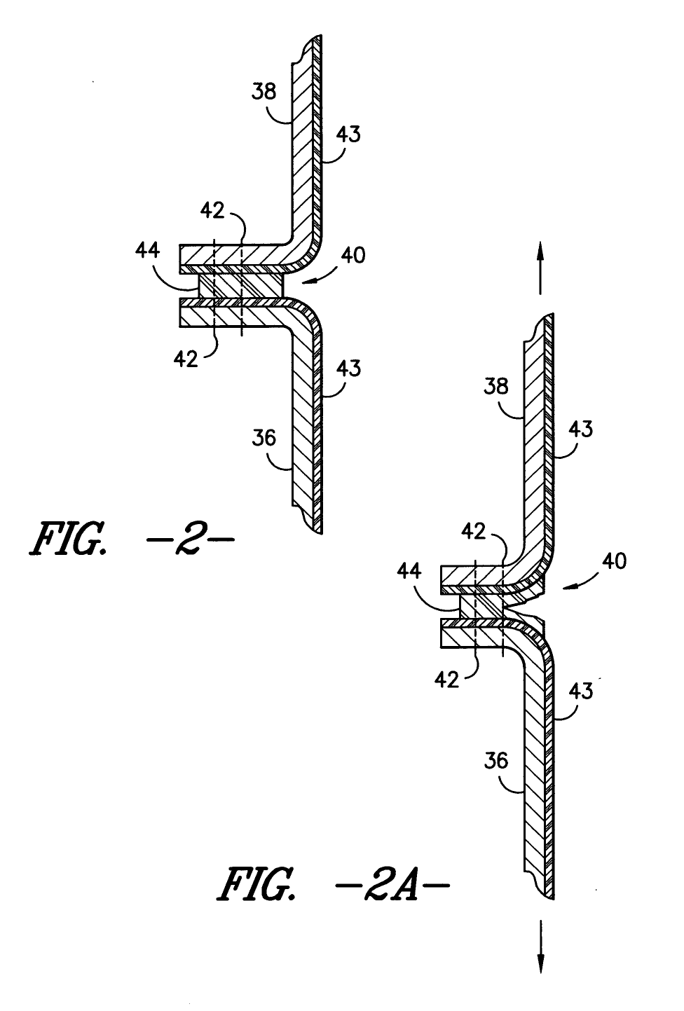

As previously indicated, the present invention provides sewn seams within an inflatable curtain adapted to greatly reduce the propensity for gas leakage under the stress of inflated deployment. By way of example only, and not limitation, an illustrative gas blocking seam construction such as may be used is illustrated in FIG. 2. While the seam is illustrated as utilizing multiple parallel sewing threads, such an arrangement is illustrative only and virtually any seamed construction may be utilized. For example, a single needle lock stitch may be utilized if desired. Moreover as will be appreciated, in order to facilitate explanation, various components of the seam are shown with enhanced dimensions and are thus not necessarily drawn to scale.

As shown, in the exemplary seam construction a first panel 36 formed from a blank of suitable construction material such as a woven fabric or the like is joined to a second panel 38 formed from a blank of suitable construction material such as a woven fabric or the like along a seam line 40 by suitable stitching threads 42. In the illustrated and potentially preferred practice, one or both of the panels 36, 38 includes a relatively light weight coating 43 of a strongly adherent permeability blocking composition across the inside surface. As will be appreciated, such coatings provide gas blockage across the non-seamed portions of the formed air bag. By way of example only, and not limitation, such coatings may include silicone, urethanes, disperse polyamides or the like. Silicone coatings having dry add on weights of about 10 to 50 grams per square meter, more preferably about 15 to about 34 grams per square meter and most preferably about 20 to about 25 grams per square meter may be particularly preferred. Of course, in the event that the panels 36, 38 have adequate permeability blocking character such coatings may be eliminated if desired. The elimination of coatings may be particularly desirable for impact absorbing cushions 16 where prolonged inflation is not necessarily required.

Whether or not a permeability blocking coating 43 is utilized, in accordance with the present invention at least a portion of the sewn seams include a sealant layer 44 sandwiched between the panels 36,38 and at least partially surrounding the stitching threads 42. In practice, the sealant layer 44 preferably runs along the length of the seam and defines a plug having a thickness dimension parallel to the sewing threads and a discrete, relatively narrow width dimension transverse to the sewing threads. The width dimension is sufficient such that at least a portion of the stitching threads are surrounded by the plug.

As will be appreciated, upon application of pressure to the curtain 20, sewn seams are placed into tension as the adjoined panels attempt to separate from one another. FIG. 2A illustrates the seam of FIG. 2 under pressure with the panels pulling away from one another in the direction of the arrows. As illustrated, upon the application of pressure the seam attempts to separate at the base thereby causing the sealant layer 44 to be stretched away from the centerline. The maximum degree of stretch within the sealant layer 44 is at the base of the seam where the panels 36, 38 spread apart from one another. As illustrated in FIG. 2A, according to the present invention, during inflation the sealant layer 44 deforms along with the adjoined panels 36, 38. The sealant layer 44 thereafter begins to fail in a cohesive manner with crack propagation stopping just short of the stitching threads 42.

It has been determined that the surface energy occurring during the formation of a crack dc may be written as follows as Tb.dc, where T is the tear energy of the sealant and b is the width of the sealant specimen. Since there is no energy dissipation in this process, all the work is spent to create the crack, and hence:
2Fdl=Tbdc (1)
Where F is the force pulling the adherent and, dl is the resultant change in length of the specimen. Since the fabric has a minimal elongation at this stage, dl=dc. Also, if the force per unit width is defined as f, then the above equation can be transformed into a simpler form:
2f=T (2)
Hence, the tearing energy is substantially independent of the thickness of the sealant and is purely a function of the force per unit width of the seam. In this particular application the sealant should be chosen to fail in a cohesive manner. As a result, the tensile strength of the adhesive should not be high enough to shift this failure mode from cohesive to adhesive mode. The determination of the above theoretical parameters was carried out through peel testing of the sealant attached to the fabric adherent.

Based on experiments it has been found that the sealant band width of more than about 5 to 10 mm is not normally necessary. Surprisingly, it was found that large widths may actually be counterproductive because they begin to induce more of an adhesion failure (i.e. peeling away from the adjacent panel) rather than a preferred cohesive failure within the sealant. The effect of the sealant width was evaluated in the tensile tester in the peel configuration to mimic the deformation in an air bag. The thickness of the sealant was evaluated at 5 mm and 10 mm widths and also the effect of a sewn seam in this process was introduced to understand if the sealant was performing as designed. A new parameter referred to herein as “Performance Strength Ratio” or PSR was defined as follows in the design stages of the various sealants and was used as a discrimination parameter for gas retention in a curtain-type air bag:

$$PSR = \frac{Peel \cdot Strength \cdot of \cdot the \cdot sealant}{Tensile \cdot Strength \cdot of \cdot the \cdot Seam \cdot in \cdot the \cdot Cushion} \qquad ( 3 )$$

In the above ratio, the sealant by itself does not provide any tensile strength to the seam in the cushion, but the sewn seam does. As a result, a lower PSR ratio is preferred but at the same time it should not be too low to result in sealant peeling from the coating on the substrate prematurely. The peel strength and seam tensile strength are preferably measured in accordance with DIN EN ISO 13934-1.

Based on these parameters it has been determined that In order to achieve the desired mechanism of cohesive failure the adhesive strength of the sealant is required to be higher than the cohesive sealant strength. Moreover, the sealant should preferably be immiscible and exhibit very low interfacial tension. In addition, the sealant material preferably adheres to the panels with a sufficient force to avoid peeling prematurely. By way of example, in order to achieve the desired performance character it is contemplated that for a typical sewn seam such as a single needle lock stitch having a tensile strength of about 178 pounds force per inch the peel strength of the sealant is preferably about 10 to about 44 pounds force per inch such that the PSR is preferably in the range of about 0.05 to about 0.25, more preferably about 0.10 to about 0.20 and most preferably about 0.18 or less. The tearing energy for the sealant layer 44 is preferably less than about 75 lbs. force per inch as calculated from equation 2 above. In order to realize these characteristics it has been found that the tensile strength of the sealant is preferably in the range of about 1.5 to about 2.5 MPa measured per JIS K6249 with a Shore hardness of less than about 25. The sealant should preferably exhibit the desired cohesive elongation and cohesive cleavage propagation even at thicknesses of less than about 1 millimeter. In actual practice the thickness of the sealant layer is preferably about 5 millimeters or less and is more preferably about 3 millimeters or less and is most preferably less than 1 millimeter.

In order to be practical for use in an air bag cushion, the material forming the sealant layer 44 is preferably curable at room temperature with gelation transition from a liquid phase to a solid rubber phase in about 150 minutes or less at room temperature (more preferably about 60 minutes or less) so as to permit seam formation between panels of material through the sealant layer within a relatively short period of time after sealant application. In actual practice, the sealant should remain in liquid form as it is applied and the initial sandwich is formed. Thereafter, the sealant should undergo gelation to a solid rubber phase prior to seaming. The ability to cure at room temperature avoids the need to subject the panels to elevated temperatures. As will be appreciated, exposure to elevated temperatures may be undesirable due to shrinkage of the panel substrate material.

After determining the desired performance and design parameters as outlined above, a number adhesive compositions were evaluated with the results outlined in Table 1 below.

TABLE 1

| | | | | Sealant Dimension | Gelation | |
|---|---|---|---|---|---|---|
| Sealant | Sealant | Sealant | Curing | Width × Thickness | Time | Failure In |
| Manufacturer | Part No. | Type | Mechanism | (mm) | (min) | Peel Test |
| Dow | CF6712 | 2-Part | Room Temp/ | 10 × 1 | 240 | Cohesive |
| | | | Heat | | | |
| Shin Etsu | X831-070 | 2-Part | Room Temp | 10 × 1 | 1440 | Cohesive |
| | X-32-2170 | 2-Part | Room Temp | 10 × 1 | 1440 | Both |
| | X-30-2070 | 2-Part | Room Temp | 10 × 1 | 1440 | Cohesive |
| Wacker | 4001 | 1-Part | Heat | 10 × 1 | 1 | Adhesive |
| | 3003 | 2-Part | Heat | 10 × 1 | 2 | Adhesive |
| Bayer-GE | TP3754 | 2-Part | Heat | 10 × 1 | 5 | Adhesive |
| Rhodia | LSRR20HS | 2-Part | Heat | 10 × 1 | 5 | Adhesive |
| Henkel | | 1-Part | Room Temp | 10 × 1 | 10 | Cohesive |
| Henkel | | 1-Part | Room Temp | 10 × 1 | 60 | Cohesive |

It was found that the one part condensation cured sealants provided by Henkel Corporation having a place of business at 1001 Trout Brook Crossing, Rocky Hill, Conn. may provide desirable performance characteristics when utilized in a proper manner. In particular such sealant materials are one-part systems that do not rely on addition curing. Moreover, such materials may be cured from liquid to a sufficiently solid rubber phase within about 10 to 60 minutes at room temperature. Most importantly, when properly applied within a seam structure such sealants exhibit the desired fully cohesive elongation and failure. Of course, it is contemplated that such sealants are exemplary only and that other sealants having the desired properties may likewise be utilized.

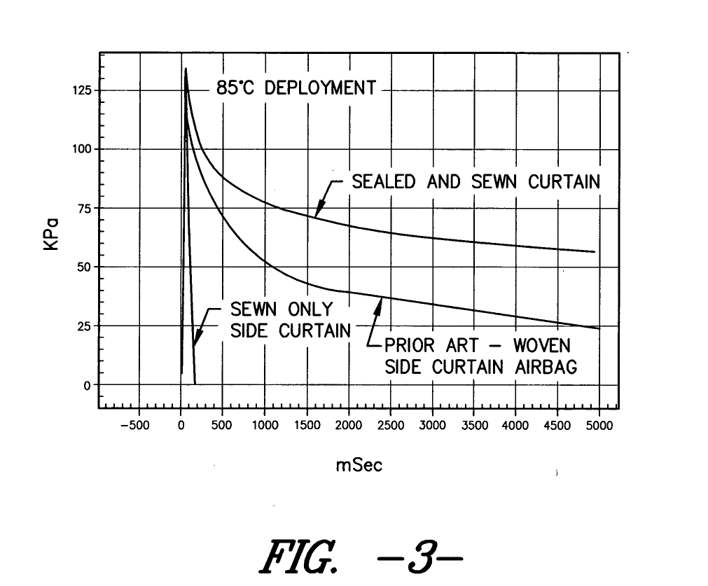

In order to demonstrate the gas retaining benefits of the present invention, the performance of a fully sewn side-curtain air bag incorporating seams with sealant characteristics as outlined above was compared to a one piece Jacquard woven curtain of the same geometry using hot deployment testing with an actual inflator. A comparative test was also run using the same curtain but without the sealant layer. In this test the one piece woven bag was formed from 420 denier nylon 6,6 yarn woven at a finished cover factor of 2049.4 and with a coating weight of 75 grams per square meter of silicone. As will be understood by those of skill in the art, the cover factor is calculated by the formula:
(dw^{1/2}×nw)+(df^{1/2}×nf)
where dw is the denier of the warp yarns, nw is the number of warp yarns per inch in the finished fabric, df is the denier of the fill yarns, and nf is the number of fill yarns per inch in the finished fabric. The sewn and sealed curtains tested utilized the same yarn but with a lower weave density corresponding to a finished cover factor of 1885.44 and with an overall coating weight of only 24 grams per square meter of silicone. Thus, the improved performance was achieved using lighter weight fabrics as well as lower coating weights thereby providing a substantially improvement over the known art. Silicone coating weights of about 20 to about 30 grams per square meter may be preferred. The results are illustrated in FIG. 3 showing that the sealed and sewn curtain retained pressures above 50 KPa for a period substantially longer than the single piece woven side-curtain air bag despite the lighter weave and lower coating weights. Moreover, the performance relative to the sewn only side-curtain demonstrates that the benefits resulted from the sealing operation.

While the present invention has been illustrated and described in relation to certain potentially preferred embodiments and practices, it is to be understood that the illustrated and described embodiments and practices are illustrative only and that the present invention is in no event to be limited thereto. Rather, it is fully contemplated that modifications and variations to the present invention will no doubt occur to those of skill in the art upon reading the above description and/or through practice of the invention. Therefore, it is intended that the present invention shall extend to all such modifications and variations as may incorporate the broad aspects of the invention in the full spirit and scope thereof.

What is claimed is:

1. An inflatable air bag for occupant protection in a transportation vehicle, the air bag comprising: a first panel comprising a textile fabric and a second panel comprising a textile fabric, wherein the first panel and the second panel are adjoined together by a sewn seam comprising at least one stitching thread extending in perforating relation between the first panel and the second panel whereby discrete segments of the first panel and the second panel are held in opposing relation to one another, and wherein a layer of gas blocking sealant of discrete width is disposed between said discrete segments of the first panel and the second panel in surrounding relation to said at least one stitching thread, the gas blocking sealant having a tensile strength in the range of about 1.5 to about 2.5 MPa and forming an adhesive bond to the first panel and the second panel with adhesive strength in excess of the internal cohesive strength of the sealant such that upon application of inflation pressure within the air bag, the sealant layer fractures in a cohesive mode at an interior position removed from the first panel and the second panel without peeling away from the first panel or the second panel and wherein the sealant is characterized by gelation from liquid to a solid rubber phase at room temperature within about 150 minutes or less.

2. The invention as recited in claim 1, wherein the sealant is characterized by a gelation time from liquid to solid of not greater than about 120 minutes at room temperature.

3. The invention as recited in claim 1, wherein the sealant is characterized by a gelation time from liquid to solid of not greater than about 90 minutes at room temperature.

4. The invention as recited in claim 1, wherein the sealant is characterized by a gelation time from liquid to solid of not greater than about 60 minutes at room temperature.

5. The invention as recited in claim 1, wherein at least one of said first panel and said second panel further comprises a coating layer disposed in contacting relation to the gas blocking sealant.

6. The invention as recited in claim 5, wherein the coating layer comprises silicone.

7. The invention as recited in claim 6, wherein the silicone is present at a coating weight of about 10 to about 50 grams per square meter.

8. The invention as recited in claim 1, wherein the layer of gas blocking sealant has a width of less than 10 millimeters and a thickness not greater than 1 millimeter.

9. The invention as recited in claim 1, wherein the sealant is characterized by a peel strength relative to the first panel and the second panel in the range of about 10 to 40 pounds force per inch and the sewn seam with sealant is characterized by a performance strength ratio of 0.05 to not more than about 0.25.

10. The invention as recited in claim 1, wherein the air bag is an inflatable curtain style air bag.

11. An inflatable air bag for occupant protection in a transportation vehicle comprising: a first panel comprising a textile fabric and a second panel comprising a textile fabric, wherein the first panel and the second panel are adjoined together by a sewn seam comprising at least one stitching thread extending in perforating relation between the first panel and the second panel whereby discrete segments of the first panel and the second panel are held in opposing relation to one another, and wherein a layer of gas blocking sealant of discrete width not greater than about 10 mm and a thickness not greater than about 3 millimeters is disposed between said discrete segments of the first panel and the second panel in surrounding relation to said at least one stitching thread, the gas blocking sealant having a tensile strength in the range of about 1.5 to about 2.5 MPa and forming an adhesive bond to the first panel and the second panel with adhesive strength in excess of the internal cohesive strength of the sealant such that upon application of inflation pressure within the air bag curtain, the sealant layer fractures in a cohesive mode at an interior position removed from the first panel and the second panel without peeling away from the first panel or the second panel, wherein the sealant is characterized by a peel strength relative to the first panel and the second panel in the range of about 10 to 40 pounds force per inch and the sewn seam with sealant is characterized by a performance strength ratio of 0.05 to not more than about 0.25 and wherein the sealant is characterized by gelation from liquid to a solid rubber phase at room temperature within about 150 minutes or less.

12. The invention as recited in claim 11, wherein the sealant is characterized by a gelation time from liquid to solid of not greater than about 120 minutes at room temperature.

13. The invention as recited in claim 11, wherein the sealant is characterized by a gelation time from liquid to solid of not greater than about 90 minutes at room temperature.

14. The invention as recited in claim 11, wherein the sealant is characterized by a gelation time from liquid to solid of not greater than about 60 minutes at room temperature.

15. The invention as recited in claim 14, wherein at least one of said first panel and said second panel further comprises a coating layer disposed in contacting relation to the gas blocking sealant.

16. The invention as recited in claim 15, wherein the coating layer comprises silicone.

17. The invention as recited in claim 16, wherein the silicone is present at a coating weight of about 10 to about 50 grams per square meter.

18. The invention as recited in claim 11, wherein the layer of gas blocking sealant has a thickness not greater than 1 millimeter.

19. The invention as recited in claim 11, wherein the air bag is an inflatable curtain style air bag.

20. An inflatable air bag curtain adapted for deployment and retained inflation across a side portion of a transportation vehicle, the air bag curtain comprising: a first panel comprising a textile fabric with a surface coated with silicone at a level of about 10 to about 30 grams per square meter and a second panel comprising a textile fabric with a surface coated with silicone at a level of about 10 to about 30 grams per square meter, wherein the first panel and the second panel are adjoined together by a sewn seam comprising at least one stitching thread extending in perforating relation between the first panel and the second panel whereby discrete segments of the first panel and the second panel are held in opposing relation with the coated surfaces of the panels facing one another, and wherein a layer of gas blocking sealant of discrete width not greater than about 10 mm and a thickness not greater than about 3 millimeters is disposed between said discrete segments of the first panel and the second panel in surrounding relation to said at least one stitching thread, the gas blocking sealant having a tensile strength in the range of about 1.5 to about 2.5 MPa and forming an adhesive bond to the coated surface of the first panel and to the coated surface of the second panel with adhesive strength in excess of the internal cohesive strength of the sealant such that upon application of inflation pressure within the air bag curtain, the sealant layer fractures in a cohesive mode at an interior position removed from the first panel and the second panel without peeling away from the first panel or the second panel and wherein the sealant is characterized by gelation from liquid to a solid rubber phase at room temperature within about 150 minutes or less.

21. The invention as recited in claim 20, wherein the sealant is characterized by a gelation time from liquid to solid of not greater than about 120 minutes at room temperature.

22. The invention as recited in claim 20, wherein the sealant is characterized by a gelation time from liquid to solid of not greater than about 90 minutes at room temperature.

23. The invention as recited in claim 20, wherein the sealant is characterized by a gelation time from liquid to solid of not greater than about 60 minutes at room temperature.

24. The invention as recited in claim 20, wherein the layer of gas blocking sealant has a thickness not greater than 1 millimeter.

25. The invention as recited in claim 24, wherein the layer of gas blocking sealant of discrete width not greater than about 10 mm.

26. An inflatable curtain air bag for occupant protection in a transportation vehicle, the air bag comprising: a first panel comprising a textile fabric and a second panel comprising a textile fabric, wherein the first panel and the second panel are adjoined together by a sewn seam comprising at least one stitching thread extending in perforating relation between the first panel and the second panel whereby discrete segments of the first panel and the second panel are held in opposing relation to one another, and wherein a layer of gas blocking sealant of discrete width is disposed between said discrete segments of the first panel and the second panel in surrounding relation to said at least one stitching thread, the gas blocking sealant forming an adhesive bond to the first panel and the second panel with adhesive strength in excess of the internal cohesive strength of the sealant such that upon application of inflation pressure within the air bag, the sealant layer fractures in a cohesive mode at an interior position removed from the first panel and the second panel without peeling away from the first panel or the second panel and wherein the sealant is characterized by gelation from liquid to a solid rubber phase within about 150 minutes or less, such that the layer of sealant is adapted for perforating sewing in less than about 150 minutes whereby said sewing may commence in less than 150 minutes.

27. The invention as recited in claim 26, wherein the sealant is characterized by a gelation time from liquid to solid of not greater than about 120 minutes, such that the layer of sealant is adapted for perforating sewing in less than about 120 minutes or less.

28. The invention as recited in claim 26, wherein the sealant is characterized by a gelation time from liquid to solid of not greater than about 90 minutes, such that the layer of sealant is adapted for perforating sewing in less than about 90 minutes or less.

29. The invention as recited in claim 26, wherein the sealant is characterized by a gelation time from liquid to solid of not greater than about 60 minutes, such that the layer of sealant is adapted for perforating sewing in less than about 60 minutes or less.
